(19) United States
(12) Patent Application Publication
(10) Pub. No.: US 2008/0194121 A1
(43) Pub. Date: Aug. 14, 2008

(54) Thin client computer

(75) Inventors: Hung-Chieh Chang, Shijr City (TW); Andrew Hou, Shijr City (TW)

Correspondence Address: TROXELL LAW OFFICE PLLC, SUITE 1404, 5205 LEESBURG PIKE, FALLS CHURCH, VA, 22041, US

(73) Assignee: Clientron Corp.

(21) Appl. No.: 11/703,828

(22) Filed: Feb. 8, 2007

(51) Int. Cl. H01R 12/00

(52) U.S. Cl. 439/59

(57) ABSTRACT

A thin client computer comprises a machine body and a base. The machine body has a motherboard mounted therein. The motherboard has a base connector on one side for exposing to the outside of the machine body. The base has an opposite connector for coupling with the base connector of the motherboard and several peripheral connection ports for coupling with several peripherals. The machine body can be coupled with the opposite connector of the base via the base connector so that the peripherals can be coupled with the peripheral connection ports of the base for further providing the machine body with more available functions.

### FIELD OF THE INVENTION

The present invention relates to a thin client computer, and more particularly to an improved thin client computer able to expand functions easily.

### BACKGROUND OF THE INVENTION

The computer has become an indispensable tool in life. Regardless of work or leisure, there are needs to utilize the computers. For instance, the machine bodies of the desktop computers have large size. Accordingly, there are several peripheral connectors mounted on the machine bodies of the desktop computers for connection with several peripherals such as printers, scanners, CD burners, and local area networks so as to provide the computers with more available functions.

Almost all kinds of electric appliances nowadays including the desktop computers are light, thin, and tiny. In addition, the monitors are changed from the traditional CRT (cathode ray tube) monitors to the current LCD (liquid crystal display) monitors. Besides, the machine bodies are also changed from traditional large type to mini type or barebone. Although the mini type or barebone machine bodies have significantly reduced sizes, there are still many peripheral connectors mounted thereon. As a result, these peripheral connectors are spaced at close intervals, causing the difficulty in connection with more than two peripherals simultaneously.

In view of the foregoing description, the motive of the present invention is to provide the general public with a thin client computer that reduces size effectively and facilitates connection to peripherals.

### SUMMARY OF THE INVENTION

A major object of the present invention is to provide a thin client computer that reduces size effectively and facilitates connection to peripherals.

In order to achieve the above-mentioned object, a thin client computer comprises a machine body and a base. The machine body has a motherboard mounted therein. The motherboard has a base connector on one side to expose to the outside of the machine body. The base has an opposite connector for coupling with the base connector of the motherboard and several peripheral connection ports for coupling with several peripherals. The machine body can be coupled with the opposite connector of the base via the base connector so that the peripherals can be coupled with the peripheral connection ports of the base for further providing the machine body with more available functions.

The aforementioned object and other advantages of the present invention will be readily clarified in the description of the preferred embodiments and the enclosed drawings of the present invention.

### BRIEF DESCRIPTION OF THE DRAWINGS

FIG. 1 is an elevational view showing a first preferred embodiment of the present invention.

FIG. 2 is a decomposed view showing the first preferred embodiment of the present invention.

FIG. 3 is a cross-sectional view showing the assembled structure in accordance with the first preferred embodiment of the present invention.

FIG. 4 is a schematic view showing a first usage in accordance with the first preferred embodiment of the present invention.

FIG. 5 is a schematic view showing a second usage in accordance with the first preferred embodiment of the present invention.

FIG. 6 is a schematic view showing the assembled structure in accordance with a second preferred embodiment of the present invention.

### DETAILED DESCRIPTION OF THE PREFERRED EMBODIMENT

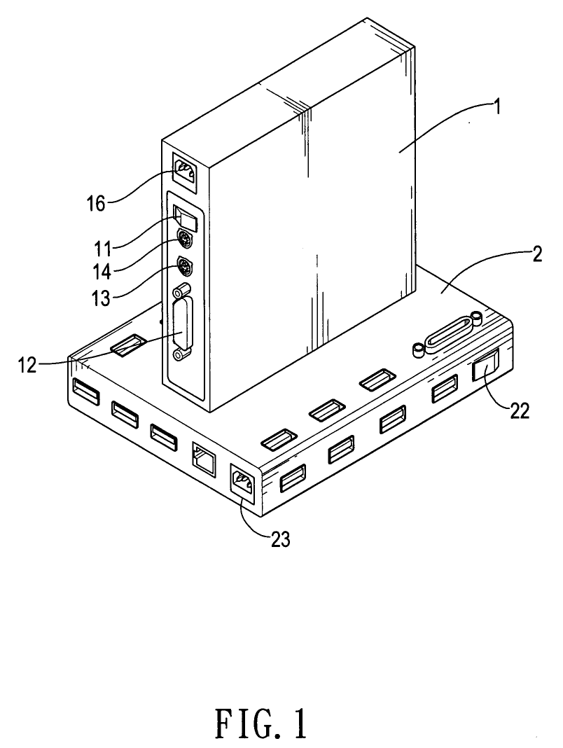

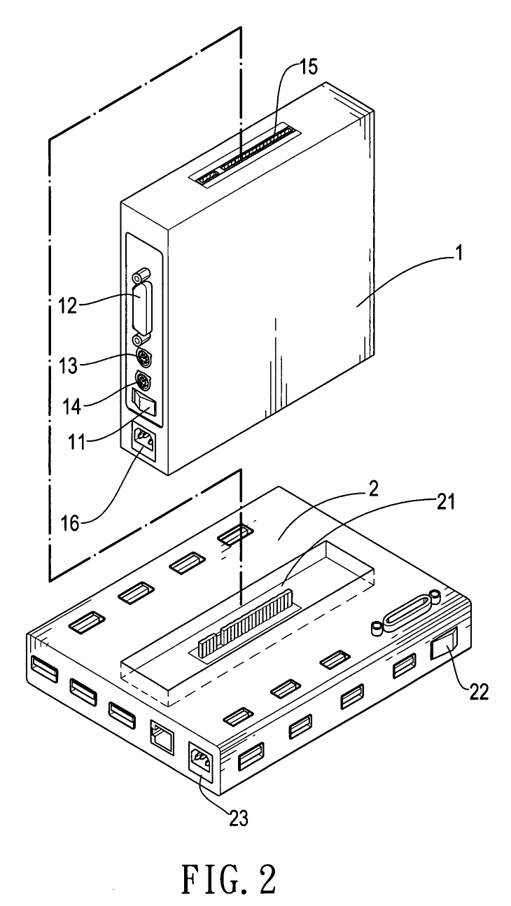

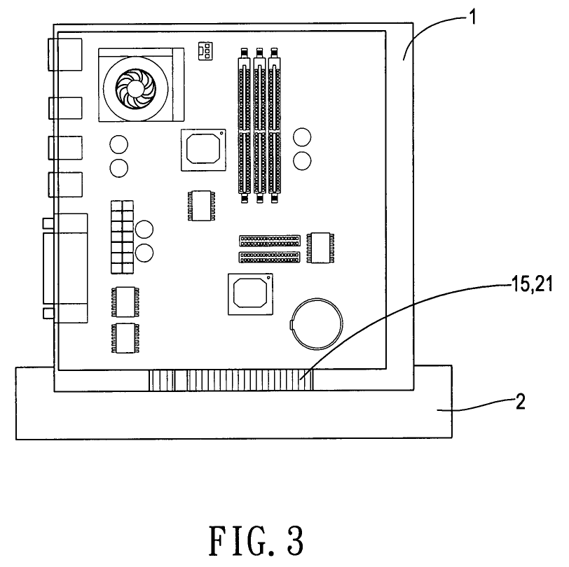

Referring to FIG. 1 through FIG. 3, a thin client computer generally comprises a machine body 1 and a base 2, wherein the machine body 1 is a box having a motherboard mounted therein. The motherboard has a base connector 15 on one side, wherein the base connector 15 is exposed to the outside of the machine body 1. In addition, a power switch 11 and four sockets including a power socket 16, a monitor socket 12, a keyboard socket 13, and a mouse socket 14 are mounted on the outside of the machine body 1. The base 2 has an opposite connector 21 corresponding to the base connector 15 of the machine body 1. The base connector 15 and the opposite connector 21 are PCI (Peripheral Component Interconnect) buses, ISA (Industry Standard Architecture) buses, PISA (PCI plus ISA), AGPs (Accelerated Graphics Ports), Digital-SubminiatVre connectors, or USBs (Universal Serial Buses), wherein the bus has, for example, 250 pins so as to raise the transmission speed for transmitting the data rapidly. In this first preferred embodiment, the opposite connector 21 is mounted on the top center of the base 2, and the opposite connector 21 has a plane or recessed periphery. In addition, the base 2 has a power switch 22, a power socket 23, and several peripheral connection ports, wherein these peripheral connection ports are USBs, printer ports, LAN (Local Area Network) ports, CCD (Charge-Coupled Device) serial ports, COM ports, and so on. In addition, the base 2 additionally has a car reader for reading or writing a commercial card such as a CF card, a SD card, a MMC card, a XD card and so forth. Moreover, the base 2 has a security module such as a fingerprint identification device or a card reading device for identifying the identity of the user (not shown).

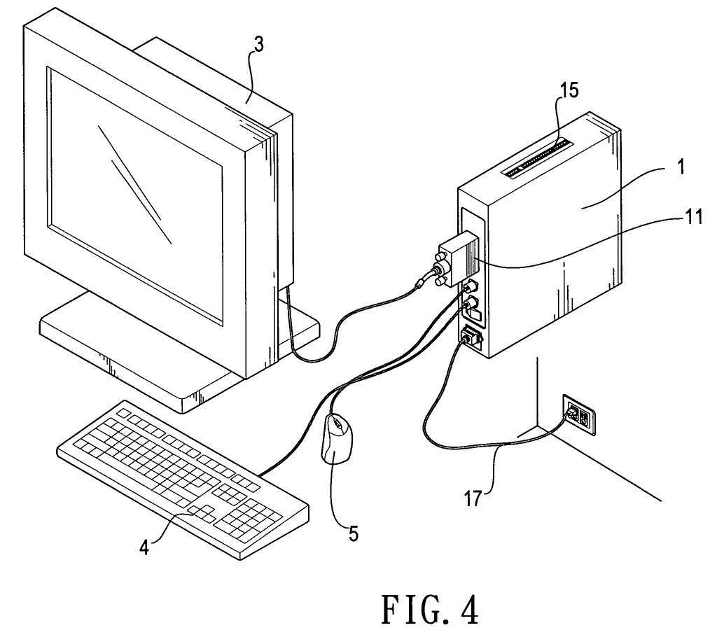

Referring to FIG. 4, a power cord 17 is inserted into the power socket 16 of the machine body 1 by one end. The other end of the power cord 17 is inserted into an indoor power socket. Next, a monitor 3, a keyboard 4, and a mouse 5 are inserted into a monitor socket 12, a keyboard socket 13, and a mouse socket 14 by their respective connectors. Next, the power switch 11 of the machine body 1 is turned on. After coupling the monitor 3, the keyboard 4, and the mouse 5 with the machine body 1, the thin client computer suitable for a typewriting task is thus completed.

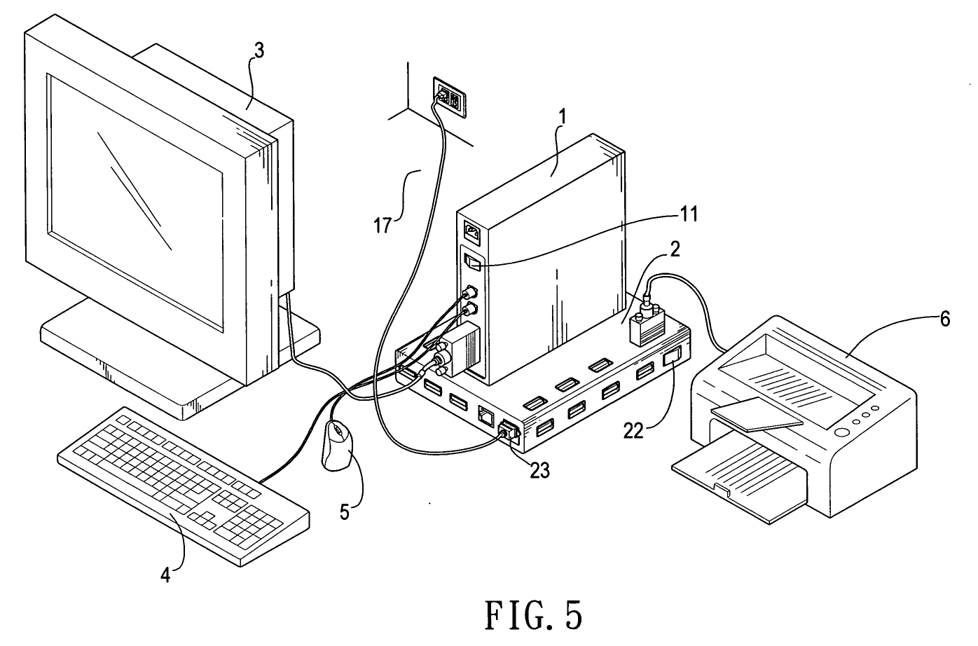

Because no peripheral connection port is formed on the machine body 1, if there is a need to additionally attach a peripheral such as a scanner or a printer 6 to this thin client computer, as shown in FIG. 5, the power cord 17 is first pulled out of the power socket 16 of the machine body 1 before coupling the base connector 15 of the machine body 1 with the opposite connector 21 of the base 2. Next, one end of the power cord 17 is inserted into the power socket 23 of the base 2, and the other end of the power cord 17 is inserted into the indoor power socket. At this moment, the power switch 22 of the base 2 is turned on so as to supply the machine body 1 with the electric power via the base connector 15. In addition, a connector of a connection line of the printer 6 is coupled with the peripheral connection port of the base 2. Accordingly, the thin client computer is basically suitable for the typewriting task and its function is expandable to facilitate the users' tasks.

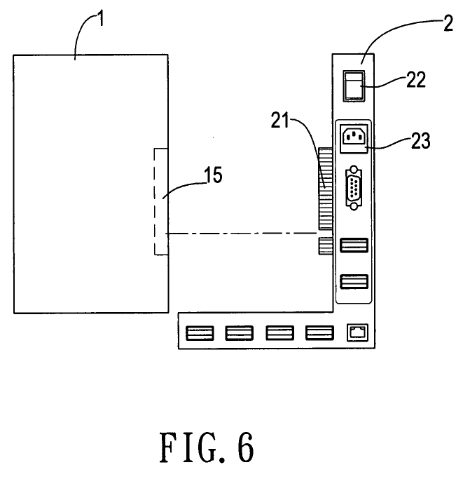

Referring further to FIG. 6, a second preferred embodiment of the present invention is shown. In this second preferred embodiment, the base connector 15 is mounted on a lateral long side of the machine body 1. The base 2 has an L-shape profile, wherein the opposite connector 21 is mounted on the vertical inner long side of the base 2. The power switch 22, several peripheral connection ports, and the power socket 23 are mounted on the periphery of the base 2 so that the machine body 1 can be coupled with the opposite connector 21 of the base 2 via the base connector 15 mounted on the lateral long side of the machine body 1. Accordingly, the machine body 1 becomes a computer having numerous peripheral connection ports mounted thereon.

In accordance with the foregoing description, the present invention has the following advantages:

1. The base connector of the improved thin client computer is exposed to the outside of the machine body to expand the connection ports easily.

2. The base connector of the machine body can be coupled with the opposite connector of the base so as to further couple various peripherals with the peripheral connection ports of the base for providing this machine body with more available functions.

In summary, an improved thin client computer of the present invention indeed achieves the anticipated object. Accordingly, the present invention satisfies the requirement for patentability and is therefore submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

1. A thin client computer comprising:
a machine body having a motherboard mounted therein, said motherboard having a base connector being PCI (Peripheral Component Interconnect) buses located on one side exposing to the outside of said machine body, the machine body has a power switch, a power socket, a monitor socket, a keyboard socket, and a mouse socket mounted thereon; and
a base having an opposite connector being PCI (Peripheral Component Interconnect) buses for coupling with said base connector of said motherboard and a plurality of peripheral connection ports for coupling with a plurality of peripherals, said base further has a power switch and a power socket mounted thereon, whereby said machine body is coupled with said opposite connector of said base via said base connector so that said peripherals are coupled with said peripheral connection ports of said base for further providing said machine body with more available functions.

2. (canceled)

3. The thin client computer of claim 1, wherein said peripheral connection ports are USBs, printer ports, LAN (Local Area Network) ports, CCD (Charge-Coupled Device) serial ports, and COM ports.

4-5. (canceled)

6. The thin client computer of claim 1, wherein said base further has a card reader for reading or writing a commercial card.

7-8. (canceled)

9. A thin client computer comprising:
a machine body having a motherboard mounted therein, said motherboard having a base connector being ISA (Industry Standard Architecture) buses on one side exposing to the outside of said machine body, the machine body has a power switch, a power socket, a monitor socket, a keyboard socket, and a mouse socket mounted thereon; and
a base having an opposite connector being ISA (Industry Standard Architecture) buses for coupling with said base connector of said motherboard and a plurality of peripheral connection ports for coupling with a plurality of peripherals, said base further has a power switch and a power socket mounted thereon, whereby said machine body is coupled with said opposite connector of said base via said base connector so that said peripherals are coupled with said peripheral connection ports of said base for further providing said machine body with more available functions.

10. The thin client computer of claim 9, wherein said peripheral connection ports are USBs, printer ports, LAN (Local Area Network) ports, COD (Charge-Coupled Device) serial ports, and COM ports.

11. The thin client computer of claim 9, wherein said base further has a card reader for reading or writing a commercial card.

12. A thin client computer comprising:
a machine body having a motherboard mounted therein, said motherboard having a base connector being PISA (PCI plus ISA) buses on one side exposing to the outside of said machine body, the machine body has a power switch, a power socket, a monitor socket, a keyboard socket, and a mouse socket mounted thereon; and
a base having an opposite connector being PISA (PCI plus ISA) buses for coupling with said base connector of said motherboard and a plurality of peripheral connection ports for coupling with a plurality of peripherals, said base further has a power switch and a power socket mounted thereon, whereby said machine body is coupled with said opposite connector of said base via said base connector so that said peripherals are coupled with said peripheral connection ports of said base for further providing said machine body with more available functions.

13. The thin client computer of claim 12, wherein said peripheral connection ports are USBs, printer ports, LAN (Local Area Network) ports, CCD (Charge-Coupled Device) serial ports, and COM ports.

14. The thin client computer of claim 12, wherein said base further has a card reader for reading or writing a commercial card.
